(19) United States
(12) Patent Application Publication
(10) Pub. No.: US 2017/0016537 A1
(43) Pub. Date: Jan. 19, 2017

(54) OIL SCRAPER PISTON RING AND METHOD FOR PRODUCING AN OIL SCRAPER PISTON RING

(71) Applicant: Federal-Mogul Burscheid GmbH, Burscheid (DE)

(72) Inventor: Dirk BAERENREUTER, Odenthal (DE)

(21) Appl. No.: 15/123,876

(22) PCT Filed: Mar. 4, 2015
(86) PCT No.: PCT/DE2015/000100

§ 371 Date: Sep. 6, 2016

(30) Foreign Application Priority Data
Mar. 4, 2014 (DE) 10 2014 003 149.7

(51) Int. Cl. F16J 9/20; B23P 15/06

(52) U.S. Cl. CPC F16J 9/206; B23P 15/06

(57) ABSTRACT

An oil scraper piston ring, includes a base body that has a running face region provided with running lands, an inner circumferential surface, upper and lower flanks, and oil drainage boreholes/slots extending between the running lands up to the inner circumferential surface. Manufacturing steps to produce the oil scraper piston rings are performed in a plurality of oil scraper piston ring blanks mounted on the same round mandrel.

### BACKGROUND OF THE INVENTION

The invention relates to an oil scraper piston ring, comprising a base body that has a running face region provided with running lands, an inner circumferential surface, upper and lower flanks, and oil drainage boreholes/slots extending between the running lands up to the inner circumferential surface.

U.S. Pat. No. 3,435,502 discloses an oil scraper piston ring of the type in question. Several piston ring blanks are clamped on a mandrel and worked by way of a profile grinding tool. The outer contour of the grouped piston rings is provided with a wear-resistant coating. Subsequently, the outer circumferential surface of the piston ring group is cylindrically machined. Finally, the desired contour is introduced into the individual piston rings by way of a profile recessing tool. In this way, individual running lands are formed, which include grooves filled with the wear-resistant material, while the remaining areas of the running face lands are at least partially free of coating.

DE 10 2010 048 079 B4 discloses a method for producing a piston ring having an axial height of <2 mm, which comprises a radially outer running face provided with at least one land, a radially inner circumferential surface, and upper and lower ring side faces extending therebetween, by providing the respective land with a contour that is conically tapered radially to the outside, then providing the running face, together with the land flanks of the respective conical land, with at least one wear-resistant layer, and subsequently subjecting only the flank-side wear layer of the flank of the respective land which forms a scraping edge and faces a crankcase to an at least partial material removal, wherein the remaining surface areas of the running face outside the respective worked land flank, including the respective land, are not subjected to any machining operation.

DE 10 2012 010 753 A1 describes a method for producing an oil scraper piston ring having an axial height of ≦2.0 mm, which comprises two spaced, radially outer running face lands, an inner circumferential surface, and upper and lower flank regions, wherein a wear-resistant coating is applied at least to the running face lands, wherein a base body made of casting material is provided with a running face profile such that, at a given axial distance of the running face lands, a groove having a predefinable width and depth is generated so that mutually opposing running land flanks extend substantially parallel to the upper and lower flank regions, a wear-resistant coating based on chromium or an alloy thereof is deposited onto the running face lands, and the final contour of the running face lands is created by way of profile grinding, wherein only the edge regions of the running face lands are machined and subsequently drainage boreholes are introduced into the region of the groove base.

### SUMMARY OF THE INVENTION

It is the object of the invention to propose an oil scraper piston ring having a low axial height (preferably ≦2.5 mm), the running face lands of which are at least partially provided with wear protection and which is suitable for mandrel production.

Moreover, a method for producing such an oil scraper piston ring is to be provided, which can be used to finish piston ring blanks at least in the region of the running faces thereof in a simple manner.

This object is achieved in an oil scraper piston ring, comprising a base body that has a running face region provided with running lands, an inner circumferential surface, upper and lower flanks, and oil drainage boreholes/slots extending between the running lands up to the inner circumferential surface, by the following features:
a) the base body has a height between 1.2 and 2.5 mm;
b) the width of the respective running land in the region of the outer circumferential surface is between 0.10 and 0.35 mm;
c) peripheral grooves are provided in the region of the running lands, which are provided with a wear-resistant coating;
d) the groove extends partially in the region of the respective running land so that a coating-free portion having a width between 0.04 and 0.25 mm is present in the region of the upper and lower flanks;
e) the coating-free portion of the respective running land has a right-angled design in the region where it merges with the respective flank, and has a sharp edge;
f) the depth of the grooves provided in the region of the running lands is between 0.005 and 0.10 mm; and
g) the height (e) of the respective running land is between 0.15 and 0.70 mm.

A preferred embodiment of the oil scraper piston ring according to the invention has the following parameters:
a) the base body has a height between 1.2 and ≦2.0 mm;
b) the width of the respective running land in the region of the outer circumferential surface is between 0.10 and 0.25 mm;
c) peripheral grooves are provided in the region of the running lands, which are provided with a wear-resistant coating;
d) the groove extends partially in the region of the respective running land so that a coating-free portion having a width between 0.04 and 0.15 mm is present in the region of the upper and lower flanks;
e) the coating-free portion of the respective running land has a right-angled design in the region where it merges with the respective flank, and has a sharp edge;
f) the depth of the grooves provided in the region of the running lands is between 0.005 and 0.06 mm; and
g) the height (e) of the respective running land is between 0.15 and 0.50 mm.

The object is also achieved by a method for producing an oil scraper piston ring by
clamping a plurality of piston ring blanks on a round mandrel;
measuring the exact position of the joints between individual piston ring blanks across the entire mandrel length;
profiling the outer circumferential surface of the piston ring blanks so that an elevation is created in the transition region of neighboring piston ring blanks;
wherein cylindrical machining of the outer circumferential surface is carried out outside the elevation;
providing at least the outer circumferential surface of the grouped piston ring blanks with a wear-resistant coating;
wherein the elevation is at least partially reproduced by the coating at least partially;
subjecting the outer circumferential surface of the coated piston ring blanks to cylindrical machining;
wherein the wear-resistant layer is removed to such an extent that a wear-resistant layer is no longer present in the transition region between individual piston ring blanks;
generating the desired outer contour of the piston ring blanks for forming an oil retention volume; and
subsequently separating the piston ring blanks and feeding them to a processing stage thereof.

The base body of the oil scraper piston ring according to the invention is preferably made of a gray cast iron material. Alternatively, however, steel wire or cast steel are also conceivable materials for producing the base body. The ring is absolutely symmetrical. The ring lands have a sharp-edged design toward the respective flank and a sharp-edged design in the direction of the oil retention volume. The preliminary profile as well as the finished profile in the running face region of the piston ring according to the invention are created on identical round mandrels. This makes land heights of only 0.15 mm, for example, possible, if needed.

After finishing of the outer contour, the mandrel is opened. Subsequently, drainage boreholes/slots are introduced into the respective running face region of the base body, and thereafter the inner contour for accommodating a spring element, which in particular is designed as a coil-spring-loaded oil control ring, is introduced.

The wear-resistant coating can advantageously be generated based on chromium or an alloy thereof. Alternative coatings based on PVD (physical vapor deposition), DLC (diamond-like carbon) or in the form of sprayed coatings are likewise conceivable, of course.

Advantageously, a wear-resistant layer having a layer thickness of <0.10 mm is applied to the blanks, which is removed to a layer thickness of ≦0.05 mm over the course of the cylindrical machining process.

The subject matter of the invention is shown in the drawings based on an exemplary embodiment and is described as follows.

### BRIEF DESCRIPTION OF THE DRAWINGS

FIG. 1 shows a schematic diagram of an oil scraper piston ring according to the invention; and

FIGS. 2a to 2e show schematic diagrams of a procedure for creating an oil scraper piston ring according to the invention in accordance with FIG. 1.

### DETAILED DESCRIPTION OF THE INVENTION

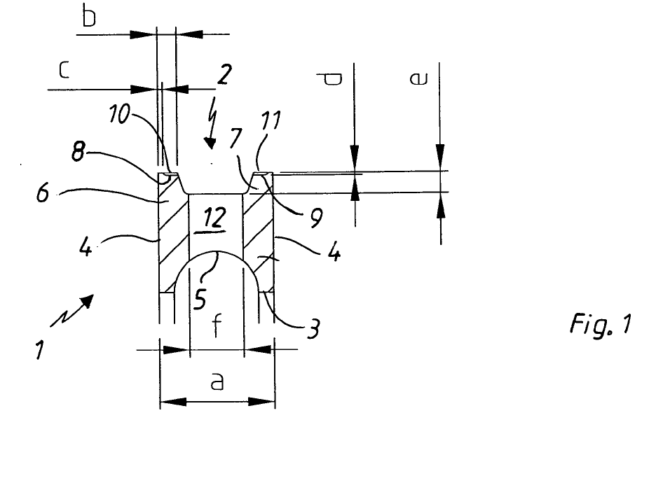

FIG. 1 shows an oil scraper piston ring according to the invention, which, by way of example, is now assigned specific values within the parameters described in claim 1.

In this example, the oil scraper piston ring according to the invention includes a base body 1 made of gray cast iron. The base body 1 has a running face region 2, an inner circumferential surface 3, upper and lower flanks 4, and a groove 5 that is provided in the region of the inner circumferential surface 3. The groove 5 is provided to accommodate a spring element, which is not shown and designed in particular as a coil spring.

In this example, the running face region 2 has two running lands 6, 7. The example shows the finished base body 1, which in this example has a groove 8, 9, which is filled with a wear-resistant material, such as chromium 10, 11, in the region of the running lands 6, 7. The ranges of the individual parameters described in claim 1 are as follows:

| | | |
|---|---|---|
| height | (a) | 1.5 mm |
| running land width | (b) | 0.15 mm |
| coating-free portion | (c) | 0.08 mm |
| groove depth | (d) | 0.01 mm |
| running land height | (e) | 0.25 mm |

In this example, drainage holes 12 designed as boreholes extend between the running face region 2 and the inner circumferential surface 2.

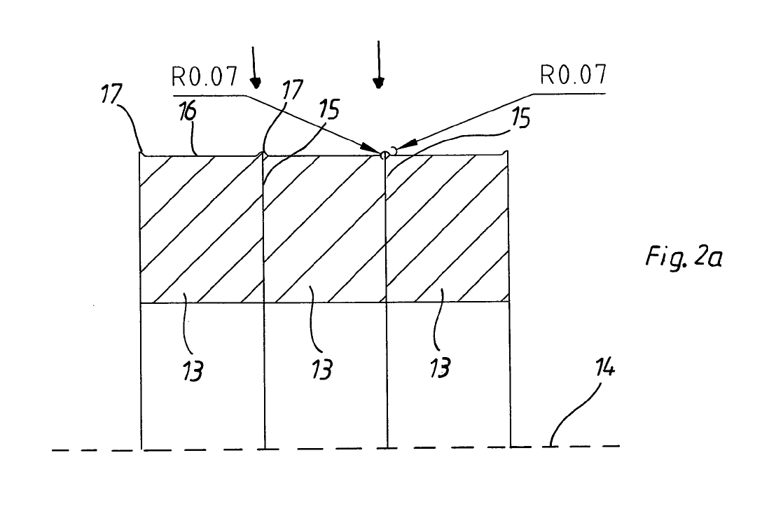

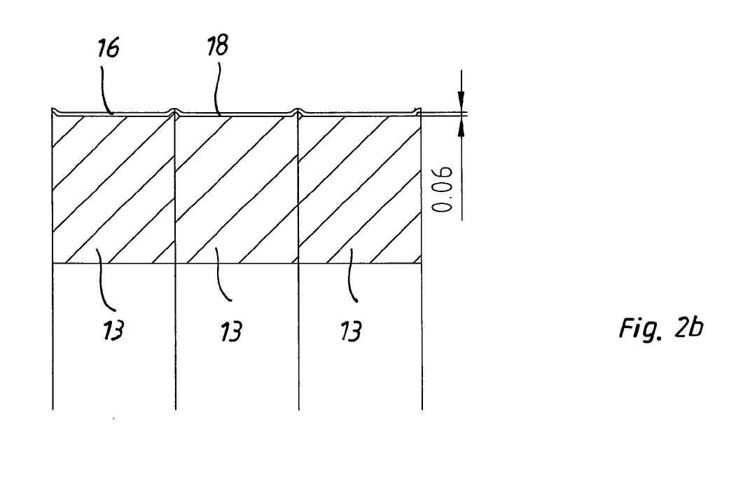

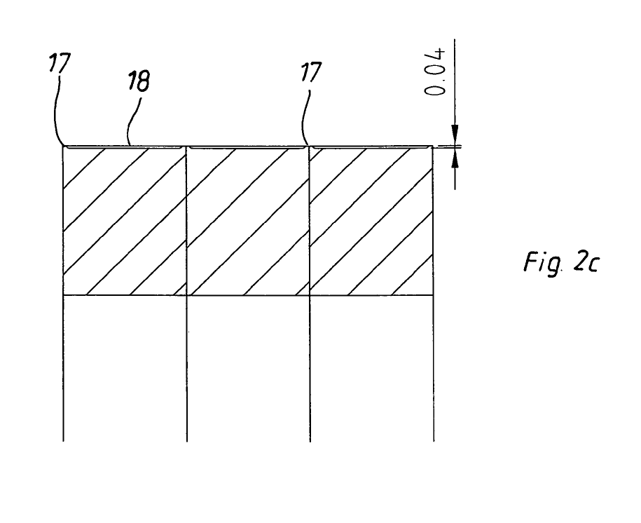

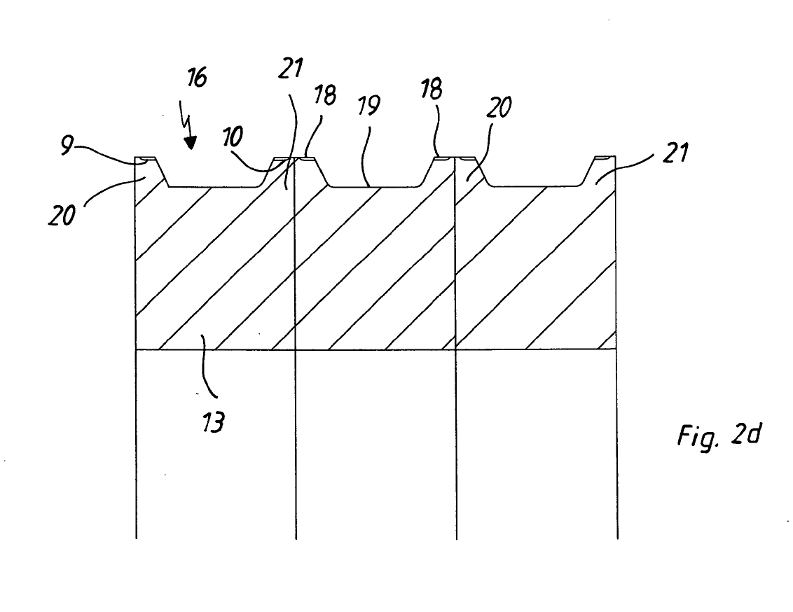

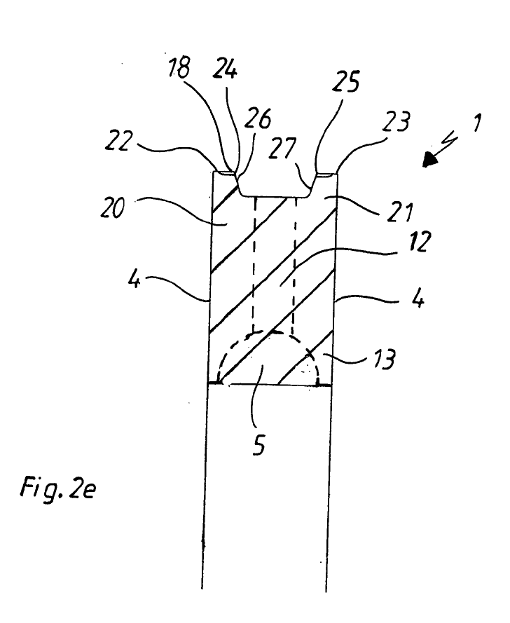

FIGS. 2a to 2e show the machining steps according to the invention.

FIG. 2a shows several grouped piston ring blanks 13, which are clamped on a round mandrel 14, which is only indicated. In a first step, the exact position of the joint 15 between neighboring piston ring blanks 13 is ascertained (↓). Thereafter, the outer circumferential surface 16 of the grouped piston ring blanks is machined so that radially protruding elevations 17 are formed in the region of the joint 15. The remaining circumferential region of the outer circumferential surface 16 is cylindrically machined.

FIG. 2b shows that the outer circumferential surface 16 of the grouped piston ring blanks 13 was provided with a wear-resistant coating 18, for example a chromium layer. Alternatively, PVD, CVD, DLC layers or sprayed coatings are also conceivable. The elevations 17 are reproduced by the coating 18. The layer thickness of the coating 18 is to be 0.10 mm in this example.

It is apparent from FIG. 2c that the coating 18, together with the elevation 17, was ground down by way of cylindrical machining, wherein a layer thickness of the coating of approximately 0.05 mm remains. The elevation 17 is coating-free, which is to say it was removed to the base material.

The machining step illustrated in FIG. 2d shows that, using a machining tool not shown in greater detail, a profile 19 was introduced into the coated outer circumferential surface 16 of the grouped piston ring blanks 13 in such a way that two running lands 20, 21 are formed. The running lands 20, 21 now only include the grooves 9, 10 provided with the coating 18 shown in FIG. 1.

FIG. 2e shows the finished base body 1 in the region of the outer circumferential surface 16. In the transition region from the respective running land 20, 21 into the associated flank 4, this base body has a coating-free sharp edge 22, 23. Likewise, a sharp edge 24, 25 is formed in the transition region from the remaining coating 18 into the inclined flank portion 26, 27.

Subsequently to separating the piston ring blanks 13, the oil drainage boreholes/slots 12 illustrated in FIG. 1 and the groove 5 for accommodating a spring element are incorporated in subsequent work steps.

1. An oil scraper piston ring, comprising a base body that has an outer circumferential surface comprising a running face region, the running face region comprising running lands, an inner circumferential surface, upper and lower flanks, and an oil drainage passage located between the running lands up and extending from the outer circumferential surface to the inner circumferential surface, wherein:
a) the base body has a height from 1.2 to 2.5 mm;
b) the width of each of the running lands at the outer circumferential surface is from 0.10 to 0.35 mm;
c) grooves are provided at the outer circumferential surface of each of the running lands, and the grooves are provided with a wear-resistant coating;
d) each groove is of width less than that of a running land so that the outer circumferential surface of each of the running grooves has a coating-free portion of a width from 0.04 to 0.25 mm is contiguous with the upper and lower flanks;
e) the coating-free portion of each of the running lands forms a right angle and a sharp edge where it meets the respective flank;
f) the depth of each of the grooves is from 0.005 to 0.10 mm; and
g) the height of each of the running lands is from 0.15 to 0.70 mm.

2. The oil scraper piston ring according to claim 1, wherein
i) the base body has a height no greater than 2.0 mm;
ii) the width of each of the running lands at the outer circumferential surface is not greater than 0.25 mm;
iii) the width of the coating-free portion of the outer circumferential surface of each of the running lands is not greater than 0.15 mm in the regions of the upper and lower flanks ;
iv) the depth grooves is not greater than 0.06 mm; and
v) the height of each of the running lands is between from 0.15 to 0.50 mm.

3. The oil scraper piston ring according to claim 1, wherein the base body is made of cast iron or steel.

4. The oil scraper piston ring according to claim 1, wherein the wear-resistant coating comprises chromium.

5. The oil scraper piston ring according to claim 1, wherein the wear-resistant coating is a PVD or DLC layer or a sprayed coating.

6. The oil scraper piston ring according to claim 1, wherein the oil drainage passages have a diameter or width of 0.4 to 1.0 mm.

7. The oil scraper piston ring according to claim 1, wherein the wear-resistant coating of each of the running lands meets a flank portion of the running face region adjacent the oil drainage passage to form a sharp edge.

8. A method for producing oil scraper piston ring, comprising
clamping a plurality of piston ring blanks on a round mandrel;
measuring the exact position of joints between individual piston ring blanks across the entire mandrel length;
profiling an outer circumferential surface of the piston ring blanks so that an elevation is created in a transition region of neighboring piston ring blanks;
wherein cylindrical machining of the outer circumferential surface is carried out outside the elevation;
providing at least the outer circumferential surface of the grouped piston ring blanks with a wear-resistant coating;
wherein the elevation is at least partially reproduced by the coating;
subjecting the outer circumferential surface of the coated piston ring blanks to cylindrical machining;
wherein the wear-resistant layer is removed to such an extent that a wear-resistant layer is no longer present in the transition region between individual piston ring blanks;
generating the desired a predetermined outer contour of the piston ring blanks for forming an oil retention volume; and
subsequently separating the piston ring blanks and feeding them a further processing stage thereof.

9. The method according to claim 8 wherein the wear-resistant coating comprises chromium.

10. The method according to claim 8, wherein a layer thickness of <0.10 mm is generated in the course of the coating process, which is removed to a thickness of <0.05 mm over the course of the cylindrical machining process.

11. The method according to claim 8, all steps comprising machining are carried out on said same round mandrel.
